(19) United States
(12) Patent Application Publication
(10) Pub. No.: US 2025/0007353 A1
(43) Pub. Date: Jan. 2, 2025

(54) DRIVE UNIT OF A MOBILITY DEVICE, IN PARTICULAR OF A VEHICLE

(71) Applicant: VALEO EMBRAYAGES, Amiens Cedex 2 (FR)

(72) Inventors: Roel VERHOOG, Cergy Pontoise (FR); Herve MAUREL, Cergy Pontoise (FR); Herve MAHE, Cergy Pontoise (FR); Eric RUMEAU, Cergy Pontoise (FR)

(73) Assignee: VALEO EMBRAYAGES, Amiens Cedex 2 (FR)

(21) Appl. No.: 18/752,874

(22) Filed: Jun. 25, 2024

(30) Foreign Application Priority Data
Jun. 29, 2023 (FR) 2306918

(51) Int. Cl. H02K 5/24; H02K 5/173; H02K 7/08

(52) U.S. Cl. CPC H02K 5/24; H02K 5/1735; H02K 7/085

(57) ABSTRACT

A drive unit of a mobility device, including an electric machine, a casing including a first shell and a second shell, the second shell being situated between the electric machine and the first shell, and a main shaft which is housed in a space delimited by the first shell and the second shell and is able to be set in rotation by the electric machine. The main shaft is mounted on the second shell by way of a first rolling bearing. The first rolling bearing is mounted without clearance on the second shell by way of first axial retention means.

The invention relates to a drive unit of a mobility device.

A drive unit generally comprises an electric motor, a casing comprising a first shell and a second shell that are connected to one another in order to delimit a space that can contain at least a main transmission shaft. The second shell cooperates with the electric machine. For example, the second shell may serve as a protective element surrounding the electric machine. Or the second shell may be mechanically connected to the stator of the electric machine. The electric machine is positioned on a first side of the second shell, whereas the first shell is positioned on a second side of the second shell.

The main shaft is intended to be set in rotation by the electric machine. The main shaft is mounted on the second shell by way of a first rolling bearing.

When the electric machine is started, vibrations are generated. Some of these vibrations reverberate on the first shell causing it to vibrate. These vibrations are sources of noise and also risk deteriorating the various elements located in the casing. For example, an intermediate shaft cooperating by gearing with the main shaft may also be located in the casing. A differential able to cooperate with the intermediate shaft may also be located in the casing. Thus, when the vibrations are generated on the first shell, it is the main shaft, the intermediate shaft and the differential which may also be affected by these various vibrations and whose proper operation may be impaired.

The invention aims to solve these problems and to propose a drive unit which makes it possible to reduce the vibrations on the first shell.

To do so, what is proposed, according to one aspect of the invention, is a drive unit of a mobility device, in particular of a vehicle, comprising
an electric machine,
a casing comprising a first shell and a second shell, the second shell being positioned between the electric machine and the first shell,
a main shaft which is housed in a space delimited by the first shell and the second shell and is able to be set in rotation by the electric machine,
the main shaft being mounted on the second shell by way of a first rolling bearing,
wherein the first rolling bearing is mounted without clearance on the second shell by way of first axial retention means.

Such a drive unit has the advantage of avoiding vibration of the first shell as much as possible and of concentrating the vibrations at the second shell, close to the electric motor.

The casing may be a gearbox casing.

The first rolling bearing is for example a ball bearing.

According to one embodiment of the invention, the first axial retention means are located between the first rolling bearing and the second shell.

According to one embodiment of the invention, the first axial retention means are formed by a circlip or a screw.

According to one embodiment of the invention, the first rolling bearing has an outer ring able to be mounted on the second shell and an inner ring able to be mounted on the main shaft, the outer ring has a first peripheral groove and the second shell has a second peripheral groove, the outer ring and the second shell being positioned with respect to one another in such a way that the circlip is housed inside the first groove and the second groove.

According to one embodiment of the invention, the first rolling bearing has an outer ring able to be mounted on the second shell and an inner ring able to be mounted on the main shaft, the second shell having a stop, the circlip being positioned bearing against the stop and against the outer ring. In one example, the circlip is positioned bearing axially against the stop and against the outer ring.

According to one embodiment of the invention, the first rolling bearing has an outer ring able to be mounted on the second shell and an inner ring able to be mounted on the main shaft, the screw being formed by a rod and by a screw head, the rod being screwed into the second shell such that the outer ring bears against the screw head. In one example, a plate is interposed axially between the screw head and the outer ring.

According to one embodiment of the invention, at least one elastic washer is mounted between the second shell and the outer ring and/or between the outer ring and the screw head.

In one exemplary embodiment of the invention, several elastic washers are mounted superposed axially with respect to one another.

According to one embodiment of the invention, the electric machine has a rotor shaft, the rotor shaft having a first end portion which is mounted around a second end portion of the main shaft, the first rolling bearing being positioned between the first end portion of the rotor shaft and the second shell.

According to one embodiment of the invention, the electric machine has a rotor shaft, the main shaft having a third end portion which is mounted around a fourth end portion of the rotor shaft, the first rolling bearing being positioned between the third end portion of the main shaft and the second shell.

According to one embodiment of the invention, the drive unit has a second rolling bearing mounted on the first shell and disposed between the main shaft and the first shell.

According to one embodiment of the invention, the second rolling bearing is mounted with clearance on the first shell. The mounting with clearance in the axial direction on the first shell prevents the transmission of vibrations within this first shell.

According to one embodiment of the invention, the second rolling bearing is a roller bearing. Such a rolling bearing withstands great radial loads.

According to one embodiment of the invention, the drive unit has an intermediate shaft which cooperates by meshing with the main shaft, the intermediate shaft being mounted on the second shell by way of a third rolling bearing, the third rolling bearing is mounted without clearance on the second shell by way of second axial retention means.

In one example, the third rolling bearing is identical to the first rolling bearing and the second axial retention means are identical to the first axial retention means.

According to one embodiment of the invention, the intermediate shaft is mounted on the first shell by way of a fifth rolling bearing, the fifth rolling bearing being a roller bearing.

According to one embodiment of the invention, the fifth rolling bearing is mounted with clearance in the axial direction on the first shell. The mounting with clearance in the axial direction on the first shell prevents the transmission of vibrations within this first shell.

According to one embodiment of the invention, the intermediate shaft is positioned in the same radial footprint as that of the electric machine.

According to one embodiment of the invention, the electric machine exhibits a substantially cylindrical footprint, notably defined by its outer diameter, the axis of rotation of the intermediate shaft is inscribed inside the outer diameter of the electric machine.

Advantageously, the electric machine may bear axially on the second shell, by way of a substantially circular bearing surface having an outer diameter, the axis of rotation of the intermediate shaft is inscribed inside the outer diameter of the bearing surface. In this way, the electric machine participates in the rigidification of the second shell. The reaction of axial forces within the main shaft and the intermediate shaft is effected on a rigidified zone of the second shell.

In a variant, the second shell may directly support the electric machine by way of a bearing ring integrally formed with the second shell, the electric machine being inserted inside this bearing ring. In this way, the reaction of axial forces within the main shaft and the intermediate shaft is effected on a rigidified zone of the second shell.

According to one embodiment of the invention, the first axial retention means and the second axial retention means are common and formed by one and the same stop. The assembly of the drive unit is thus facilitated.

According to one embodiment of the invention, the first axial retention means and the second axial retention means are offset axially and supported by one and the same stop.

Preferably, the stop may comprise a common plate provided with two orifices arranged for the passage of the main shaft and of the intermediate shaft.

According to one embodiment of the invention, the drive unit has a differential which cooperates by meshing with the intermediate shaft, the differential being mounted on the second shell by way of a fourth rolling bearing, the fourth rolling bearing being mounted without clearance on the second shell by way of third axial retention means.

In one example, the fourth rolling bearing is identical to the first rolling bearing and the third axial retention means are identical to the first axial retention means.

According to one embodiment of the invention, the main shaft and the intermediate shaft cooperate by meshing by way of respectively a first toothing and a second toothing. The intermediate shaft and the differential cooperate by meshing by way of respectively a third toothing and a fourth toothing. The first toothing, the second toothing, the third toothing and the fourth toothing may be formed in such a way that, when the main shaft, the intermediate shaft and the differential are meshed with one another, a first axial force E1 is generated by the main shaft, a second axial force E2 is generated by the intermediate shaft and a third axial force E3 is generated by the differential.

According to the invention, regardless of the direction of rotation of the main shaft, the different axial loads resulting from the different axial forces E1, E2 and E3 are all transmitted directly to the second shell or indirectly by way of axial retention means to the second shell.

According to one embodiment of the invention, the first toothing, the second toothing, the third toothing and the fourth toothing each have a helical form.

According to one embodiment of the invention, the helical form of the toothings is selected so as to compensate for the respective axial forces.

Further features and advantages of the invention will become apparent from reading the following description, with reference to the appended figures.

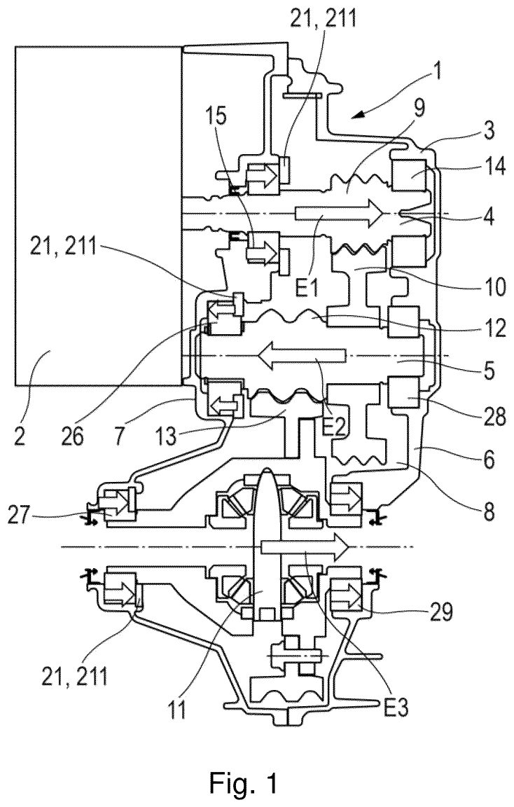

FIG. 1 illustrates a drive unit of a vehicle, according to a first embodiment of the invention;

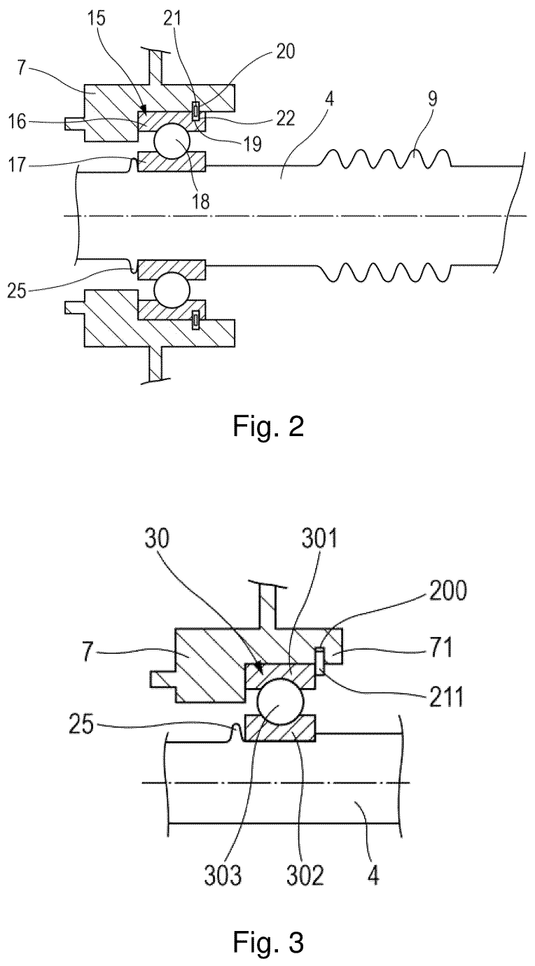

FIG. 2 illustrates an enlargement of a mounting zone of a main shaft on a casing of the drive unit, according to the first embodiment of the invention;

FIG. 3 illustrates an enlargement of a mounting zone of a main shaft on a casing of the drive unit, according to a second embodiment of the invention;

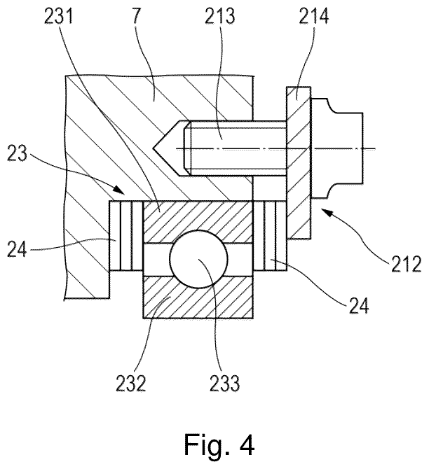

FIG. 4 illustrates a rolling bearing of a drive unit of a vehicle, according to a third embodiment of the invention;

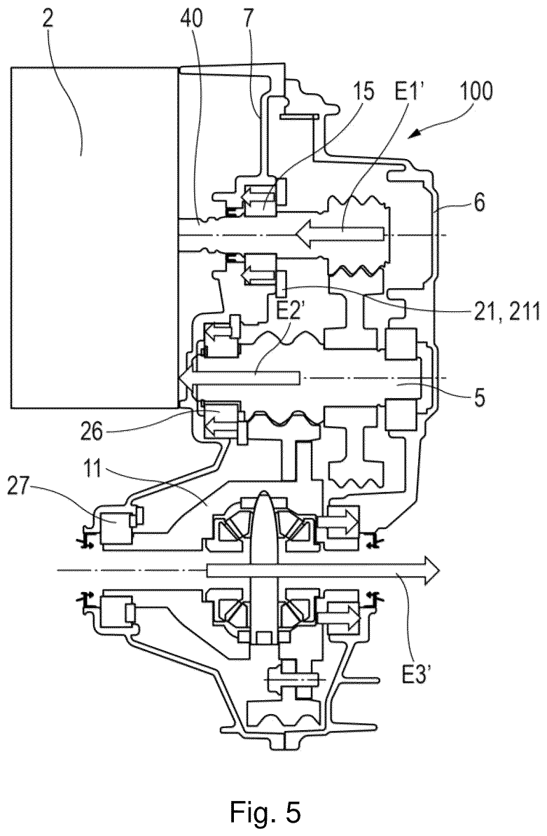

FIG. 5 illustrates a drive unit of a vehicle, according to a fourth embodiment of the invention;

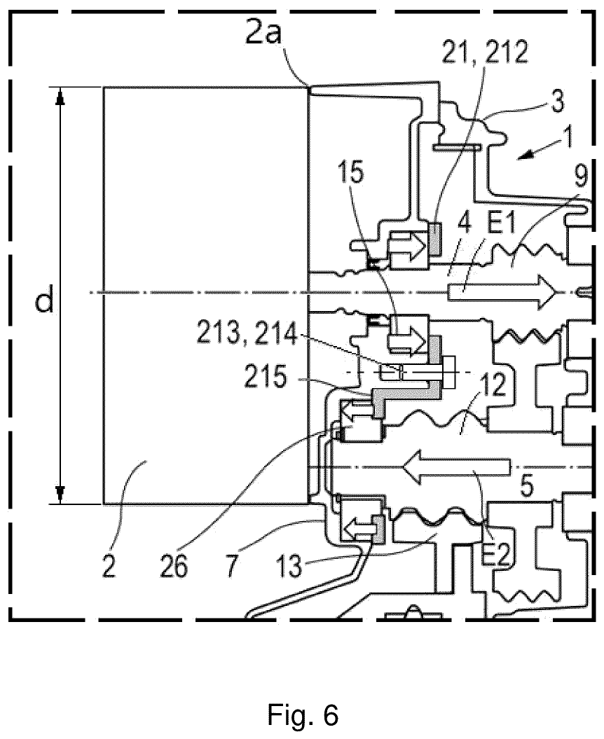

FIG. 6 illustrates a drive unit of a vehicle, according to a fifth embodiment of the invention.

FIG. 1 illustrates a drive unit 1 of a vehicle intended more particularly, but not exclusively, for a personal transporter according to a first embodiment of the invention. This drive unit 1 has an electric machine 2, a casing 3, a main shaft 4, an intermediate shaft 5 and a differential 11. The differential 11 splits the torque between two output half-shafts (not shown in FIG. 1). The casing 3 has a first shell 6 and a second shell 7. The first shell 6 and the second shell 7 are fixedly connected to one another so as to delimit a space 8. The second shell 7 is connected to the electric machine 2 by a first side and is connected to the first shell 6 by a second side opposite the first side. The second shell 7 may be part of a protective cover for the electric machine 2.

The main shaft 4 is driven directly by the electric machine 2. In one example that is not illustrated, the electric machine 2 has a rotor shaft with a first end portion which is mounted around a second end portion of the main shaft 4 (not illustrated). Or, in another example, the main shaft 4 has a third end portion which is mounted around a fourth end portion of the rotor shaft (not illustrated).

The intermediate shaft 5 is connected to the main shaft 4 by meshing of the main shaft 4 and of the intermediate shaft 5 with one another. To this end, the main shaft 4 has a first toothing 9 and the intermediate shaft 5 has a second toothing 10. The main shaft 4 and the intermediate shaft 5 cooperate by meshing of the first toothing 9 and of the second toothing 10 with one another.

The intermediate shaft 5 is intended to also cooperate with the differential 11. To this end, the intermediate shaft 5 has a third toothing 12 and the differential 11 has a fourth toothing 13. The intermediate shaft 5 and the differential 11 cooperate with one another by meshing of the third toothing 12 and of the fourth toothing 13 with one another.

The first toothing 9 and the third toothing 12 are formed directly on the main shaft 4 and on the intermediate shaft 5, respectively. Whereas the second toothing 10 and the fourth toothing 13 are each formed by an attached toothed wheel.

According to the exemplary embodiment in FIG. 1, the main shaft 4, the intermediate shaft 5 and the differential 11 are mounted on the second shell 7 by way of respectively a first rolling bearing 15, a second rolling bearing 26 and a third rolling bearing 27.

The main shaft 4, the intermediate shaft 5 and the differential 11 are also mounted on the first shell 6 by way of respectively a fourth rolling bearing 14, a fifth rolling bearing 28 and a sixth rolling bearing 29.

The first rolling bearing 15 is intended to be positioned directly in contact with the main shaft 4. However, in a variant that is not illustrated, as mentioned above, when the rotor shaft is mounted on the main shaft 4, the first rolling bearing 15 is mounted indirectly on the main shaft 4 by way of the rotor shaft (not illustrated).

The first rolling bearing 15 has an outer ring 16, an inner ring 17 and balls, such as 18, disposed between the outer ring 16 and the inner ring 17 (FIG. 2). The outer ring 16 is able to be mounted on the second shell 7. The inner ring 17 is able to be mounted directly on the main shaft 4 or indirectly on the main shaft 4 by way of the rotor shaft (not illustrated).

The outer ring 16 has a first peripheral groove 19 and the second shell 7 has a second peripheral groove 20. The outer ring 16 and the second shell 7 are positioned with respect to one another in such a way that the first peripheral groove 19 and the second peripheral groove 20 are positioned facing one another so as to form a housing 22 in which a circlip 21 is inserted.

The inner ring 17 is mounted on the main shaft 4 while bearing axially against a protuberance 25. This protuberance may be, as illustrated, a protrusion of the main shaft 4 or an attached ring (not illustrated) or another circlip (not illustrated).

In a variant in FIG. 3, a second embodiment with a first rolling bearing 30 having an outer ring 301, an inner ring 302 and balls 303 disposed between the outer ring 301 and the inner ring 302 is illustrated. The outer ring 301 is mounted on the second shell 7, whereas the inner ring 302 is mounted on the main shaft 4. A third peripheral groove 200 is formed solely by the second shell 7. This peripheral groove 200 is able to receive a circlip 211. Thus, the outer ring 161 is positioned axially bearing, by a first side, directly against the second shell 7 and, by a second side opposite the first side, indirectly against the second shell 7 by way of the circlip 211. The circlip 211 is then wedged inside the peripheral groove 200 between the outer ring 301 and a stop 71 formed by the second shell 7.

In another variant in FIG. 4, a third embodiment of the invention with a first rolling bearing 23 having an outer ring 231, an inner ring 232 and balls 233 disposed between the outer ring 231 and the inner ring 232 is illustrated. A stop 212 is mounted on the second shell 7 and is formed by a screw equipped with a rod 213 and a screw head 214. The rod 213 is screwed to the shell 7 in such a way that the screw head 214 is placed bearing against the outer ring 231.

Elastic washers, such as 24, may be disposed between the second shell 7 and the outer ring 231 by a first side and between the outer ring 231 and the screw head 214 by a second side.

The second rolling bearing 26 and the third rolling bearing 27 may each be of identical configuration to one of the first rolling bearings 15, 30 or 23 as described above.

The fourth rolling bearing 14 is a roller bearing. Such a rolling bearing withstands great radial loads.

The fifth rolling bearing 28 and the sixth rolling bearing 29 may each be of identical configuration to the fourth rolling bearing.

FIG. 5 illustrates a drive unit 100 of a vehicle intended more particularly, but not exclusively, for a personal transporter according to a fourth embodiment of the invention. This drive unit 100 differs from the one illustrated in FIG. 1 in that it has a main shaft 40 which is supported solely on the second shell 7 by a rolling bearing identical to the first rolling bearing 15. This drive unit 100 also differs from the one illustrated in FIG. 1 in that the direction of the forces generated by the main shaft 4 is reversed.

In the first embodiment in FIG. 1, the first toothing 9, the second toothing 10, the third toothing 12 and the fourth toothing 13 each have a helical form. The first toothing 9 and the second toothing 10 are formed in such a way that, when the main shaft 4, the intermediate shaft 5 and the differential 11 are meshed with one another in a first direction of rotation of the main shaft 4, a first axial force E1 is generated by the main shaft 4, a second axial force E2 is generated by the intermediate shaft 5 and a third axial force E3 is generated by the differential 11. The first axial force E1 is directed from the second shell 7 towards the first shell 6. The second axial force E2 is directed from the first shell 6 towards the second shell 7. The third force E3 is directed from the second shell 7 towards the first shell 6. In this first direction of rotation of the main shaft 4, the different axial loads resulting from the different axial forces E1, E2 and E3 are all transmitted directly or indirectly by way of the circlip 21 to the second shell 7.

In the example in FIG. 5, axial forces E1′, E2′ and E3′ equivalent to the axial forces E1, E2 and E3 are also shown. It may be noted that the drive unit 100 is configured in such a way that only the axial force E1′ is reversed with respect to the axial force E1 as illustrated in FIG. 1. The direction of the axial force of E2′ and E3′ is identical to the direction of the axial force of E2 and E3. In the same way as for the example in FIG. 1, the different axial loads resulting from the different axial forces E1′, E2′ and E3′ are all transmitted directly or indirectly by way of the circlip 21 to the second shell 7.

FIG. 6 illustrates a drive unit of a motorized vehicle according to a fifth embodiment of the invention. This drive unit differs from the one illustrated in FIG. 1 in that it has first axial retention means and second axial retention means that are common and formed by one and the same stop 212.

In this example, the first axial retention means and the second axial retention means are offset axially and supported by one and the same stop 212. The stop 212 comprises a common plate 215 provided with two orifices arranged for the passage of the main shaft 4 and of the intermediate shaft 5.

The stop 212 is mounted on the second shell 7 and is formed by a screw equipped with a rod 213 and a screw head 214. The rod is screwed to the second shell 7 in such a way that the screw head 214 is placed bearing against the common plate 215.

In this example, the electric machine 2 exhibits a substantially cylindrical footprint, notably defined by its outer diameter d, the axis of rotation of the intermediate shaft 5 is inscribed inside the outer diameter d of the electric machine.

Also, the electric machine bears axially on the second shell 7, by way of a substantially circular bearing surface 2a having an outer diameter d, the axis of rotation of the intermediate shaft 5 is inscribed inside the outer diameter d of the bearing surface 2a.

1. Drive unit of a mobility device, in particular of a vehicle, comprising
an electric machine,
a casing comprising a first shell and a second shell, the second shell being situated between the electric machine and the first shell,
a main shaft which is housed in a space delimited by the first shell and the second shell and is able to be set in rotation by the electric machine,
the main shaft being mounted on the second shell by way of a first rolling bearing,
wherein the first rolling bearing is mounted without clearance on the second shell by way of first axial retention means.

2. Drive unit according to claim 1, wherein the first axial retention means are located between the first rolling bearing and the second shell.

3. Drive unit according to claim 1, wherein the first axial retention means are formed by a circlip or a screw.

4. Drive unit according to claim 3, wherein the first rolling bearing has an outer ring able to be mounted on the second shell and an inner ring able to be mounted on the main shaft, the outer ring has a first peripheral groove and the second shell has a second peripheral groove, the outer ring and the second shell being positioned with respect to one another in such a way that the circlip is housed inside the first groove and the second groove.

5. Drive unit according to claim 3, wherein the first rolling bearing has an outer ring able to be mounted on the second shell and an inner ring able to be mounted on the main shaft, the second shell having a stop, the circlip being positioned bearing against the stop and against the outer ring.

6. Drive unit according to claim 3, wherein the first rolling bearing has an outer ring able to be mounted on the second shell and an inner ring able to be mounted on the main shaft, the screw being formed by a rod and by a screw head, the rod being screwed into the second shell such that the outer ring bears against the screw head.

7. Drive unit according to claim 6, wherein at least one elastic washer is mounted between the second shell and the outer ring and/or between the outer ring and the screw head.

8. Drive unit according to claim 1, wherein it has a second rolling bearing mounted on the first shell and disposed between the main shaft and the first shell.

9. Drive unit according to claim 8, wherein the second rolling bearing is a roller bearing.

10. Drive unit according to claim 9, wherein the second rolling bearing is mounted with clearance on the first shell.

11. Drive unit according to claim 1, wherein it has an intermediate shaft which cooperates by meshing with the main shaft, the intermediate shaft being mounted on the second shell by way of a third rolling bearing, the third rolling bearing is mounted without clearance on the second shell by way of second axial retention means.

12. Drive unit according to claim 11, wherein the intermediate shaft is mounted on the first shell by way of a fifth rolling bearing, the fifth rolling bearing being a roller bearing.

13. Drive unit according to claim 11, wherein the intermediate shaft is positioned in the same radial footprint as that of the electric machine.

14. Drive unit according to claim 12, wherein it has a differential which cooperates by meshing with the intermediate shaft, the differential being mounted on the second shell by way of a fourth rolling bearing, the fourth rolling bearing being mounted without clearance on the second shell by way of third axial retention means.

15. Drive unit according to claim 2, wherein the first axial retention means are formed by a circlip or a screw.

16. Drive unit according to claim 2, wherein it has a second rolling bearing mounted on the first shell and disposed between the main shaft and the first shell.

17. Drive unit according to claim 2, wherein it has an intermediate shaft which cooperates by meshing with the main shaft, the intermediate shaft being mounted on the second shell by way of a third rolling bearing, the third rolling bearing is mounted without clearance on the second shell by way of second axial retention means.

18. Drive unit according to claim 12, wherein the intermediate shaft is positioned in the same radial footprint as that of the electric machine.

19. Drive unit according to claim 13, wherein it has a differential which cooperates by meshing with the intermediate shaft, the differential being mounted on the second shell by way of a fourth rolling bearing, the fourth rolling bearing being mounted without clearance on the second shell by way of third axial retention means.

20. Drive unit according to claim 3, wherein it has a second rolling bearing mounted on the first shell and disposed between the main shaft and the first shell.
